(19) United States
(12) Patent Application Publication
(10) Pub. No.: US 2012/0175896 A1
(43) Pub. Date: Jul. 12, 2012

(54) VEHICLE DOOR LATCH

(76) Inventor: Alfredo Martinez, Cd. Juarez (MX)

(21) Appl. No.: 13/101,382

(22) Filed: May 5, 2011

Related U.S. Application Data
(60) Provisional application No. 61/331,576, filed on May 5, 2010.

(51) Int. Cl. E05B 65/32

(52) U.S. Cl. 292/199; 292/200

(57) ABSTRACT

A vehicle door latch assembly is disclosed herein, the vehicle latch assembly having: a fork bolt movably secured to the latch assembly, the fork bolt being capable of movement between a latched position and an unlatched position; a detent lever movably secured to the latch assembly, the detent lever being capable of movement between an engaged position and a disengaged position, the detent lever retains the fork bolt in the latched position when the detent lever is in the engaged position and an engagement surface of the detent lever contacts an engagement surface of the fork bolt; and an inertia block out assembly for preventing the detent lever from moving into the disengaged position until a predetermined force is applied to the detent lever to move it to the disengaged position when the fork bolt is in the latched position.

### CROSS REFERENCE TO RELATED APPLICATIONS

This application claims the benefit of U.S. Provisional Patent Application No. 61/331,576 filed May 5, 2010 the contents of which are incorporated herein by reference thereto.

### BACKGROUND

Exemplary embodiments of the present invention relate to door and movable panel latches and, more particularly, to door and movable panel latches for vehicles.

A vehicle frequently includes displaceable panels such as doors, hood, trunk lid, hatch and the like which are affixed for hinged or sliding engagement with a host vehicle body. Cooperating systems of latches and strikers are typically provided to ensure that such panels remain secured in their fully closed position when the panel is closed.

A door latch typically includes a fork bolt that is pivoted between an unlatched position and a primary latched position when the door is closed to latch the door in the closed position. The fork bolt is typically held in the primary latched position by a detent lever that pivots between an engaged position and a disengaged position. The detent lever is spring biased into the engaged position and thus, holds the fork bolt in the primary latched position when in the engaged position and releases the fork bolt when it is moved to the disengaged position so that the door can be opened.

The fork bolt is pivoted to the primary latched position by a striker attached to, for example, an associated door jamb when the door is closed. Once in the primary latched position, the detent lever engages the fork bolt to ensure the assembly remains latched.

Accordingly, it is desirable to provide a latch assembly wherein the detent lever is prevented from inadvertently being moved into a disengaged position.

### SUMMARY OF THE INVENTION

In accordance with one exemplary embodiment of the invention, a latch assembly is provided. The latch assembly having: a fork bolt movably secured to the latch assembly, the fork bolt being capable of movement between a latched position and an unlatched position; a detent lever movably secured to the latch assembly, the detent lever being capable of movement between an engaged position and a disengaged position, the detent lever retains the fork bolt in the latched position when the detent lever is in the engaged position and an engagement surface of the detent lever contacts an engagement surface of the fork bolt; and an inertia block out assembly for preventing the detent lever from moving into the disengaged position until a predetermined force is applied to the detent lever to move it to the disengaged position when the fork bolt is in the latched position.

In accordance with another exemplary embodiment of the present invention, a method of preventing a detent lever of a vehicle door latch assembly from moving to a disengaged position when the detent lever has been moved to an engaged position by a remotely activated actuator is provided. The method including the steps of: pivotally securing a fork bolt to the vehicle door latch assembly for movement between an unlatched position and a latched position; pivotally securing the detent lever to the vehicle door latch assembly for movement between the engaged position and the disengaged position wherein a contact surface of the detent lever engages a contact surface of the fork bolt when the detent lever is in the engaged position and the fork bolt is in the latched position; and preventing the detent lever from moving to the disengaged position from the engaged position by restricting movement of the detent lever until a predetermined amount of force is applied to the detent lever.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a perspective view illustrating a latch assembly in accordance with an exemplary embodiment of the present invention wherein the inertia block out lever is activated;

FIG. 2 is another view illustrating the latch assembly of FIG. 1;

FIG. 3 is a view illustrating the opening of the latch assembly when the inertia block out lever was activated;

FIG. 4 is a view illustrating the opening of the latch assembly when the inertia block out lever was deactivated; and

FIG. 5 is flow chart illustrating an exemplary embodiment of the present invention.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to an apparatus and method for providing a latch assembly. Furthermore, exemplary embodiments are directed to a latch assembly having a fork bolt movably secured thereto for movement between a latched position and an unlatched position. The latch assembly further comprises a detent lever capable of movement between an engaged position and a disengaged position, the detent lever retains the fork bolt in the latched position when the detent lever is in the engaged position and an engagement surface of the detent lever contacts an engagement surface of the fork bolt. The latch assembly also includes an inertia block out assembly for preventing the detent lever from moving into the disengaged position until a predetermined force is applied to the detent lever to move it to the disengaged position when the fork bolt is in the latched position.

The door latch functions in a well known manner to latch the door when it is closed and to lock the door in the closed position or to unlock and unlatch the door so that the door can be opened manually.

In general terms, the door latch has a forkbolt that engages a striker in the door jamb to latch the door when it is closed and a spring biased detent lever that engages and holds the forkbolt in the latched position. The door latch also typically has a release mechanism for moving the detent to a position releasing the forkbolt so that the door can be unlatched and opened and a lock-unlock mechanism for disabling the release mechanism to prevent unauthorized unlatching of the door.

In one non-limiting exemplary embodiment, the latch assembly is configured to block the detent lever in order to avoid any undesired opening especially when the latch or detent lever could be exposed to a high acceleration.

In one implementation, the latch assembly has a motor for driving a worm gear that has a mechanism or lever rotatably mounted on the worm gear in the same axis of rotation the worm gear is rotated. The lever is connected to the worm gear via a spring or driver spring that pushes the lever to a controlled position when the worm gear is rotated by engaging a hard stop on the worm gear. The spring will be strong enough to perform normal activation and deactivation of a block out mechanism through powering the motor and rotating the worm gear without any relative movement between the lever and the worm gear. Another lever or blockout lever will be pivoted proximate to the detent lever in order to block the detent when the lever is rotated by the drive lever coupled to the worm gear. The spring or driver spring also works as a safety feature because it provides movement on the actuator providing an emergency manual release mechanism. For example and in the case of loss of power or motor failure, the driver spring will just add an extra load to open the door, however the enough extra load will be enough to prevent undesired opening events due to high accelerations on the latch assembly.

Reference is made to the following U.S. Pat. Nos.: 3,969,789; 6,053,543 and 6,568,741 and U.S. Patent Publication No. 2002/0163207 the contents each of which are incorporated herein by reference thereto.

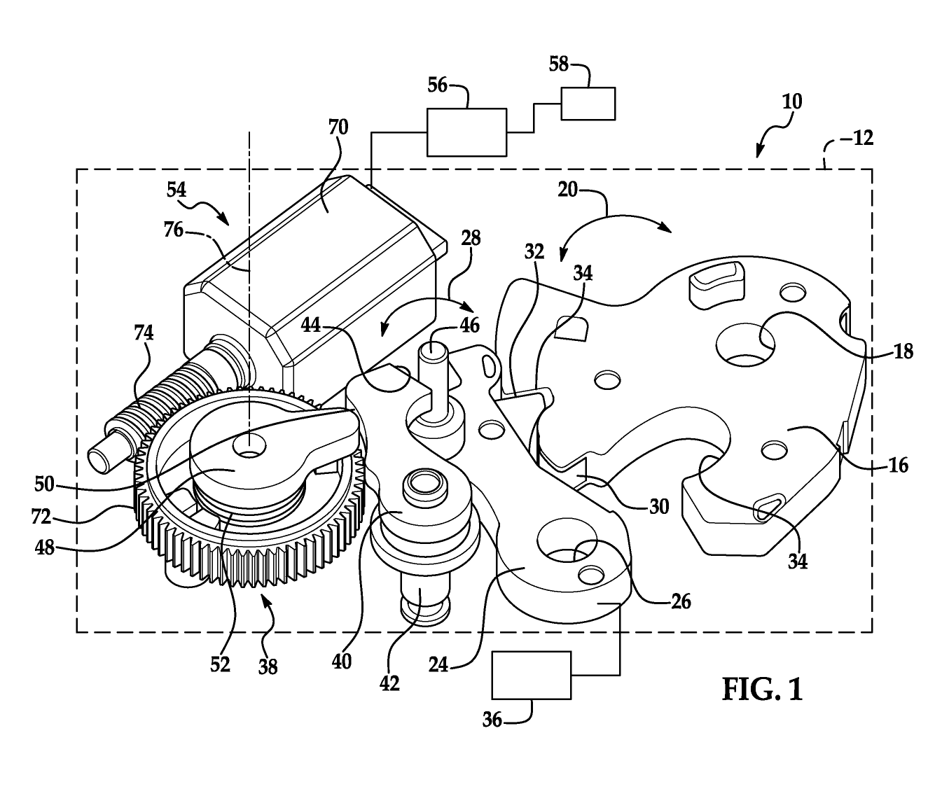

Referring now to FIGS. 1-4, a vehicle compartment latch or latch assembly 10 in accordance with an exemplary embodiment of the present invention is illustrated. In one embodiment, the vehicle compartment latch 10 comprises a frame plate or support 12 that is adapted for fastening to a vehicle proximate to a compartment closure.

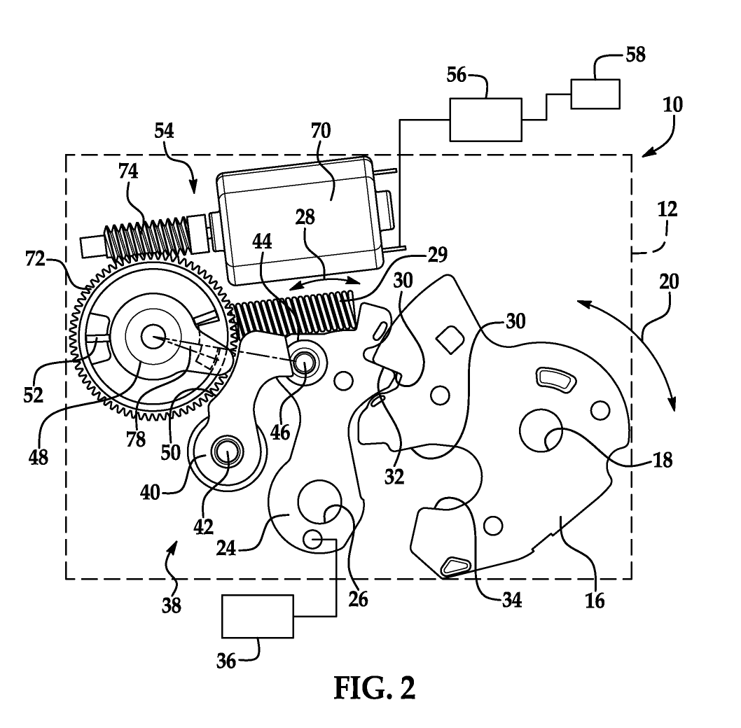

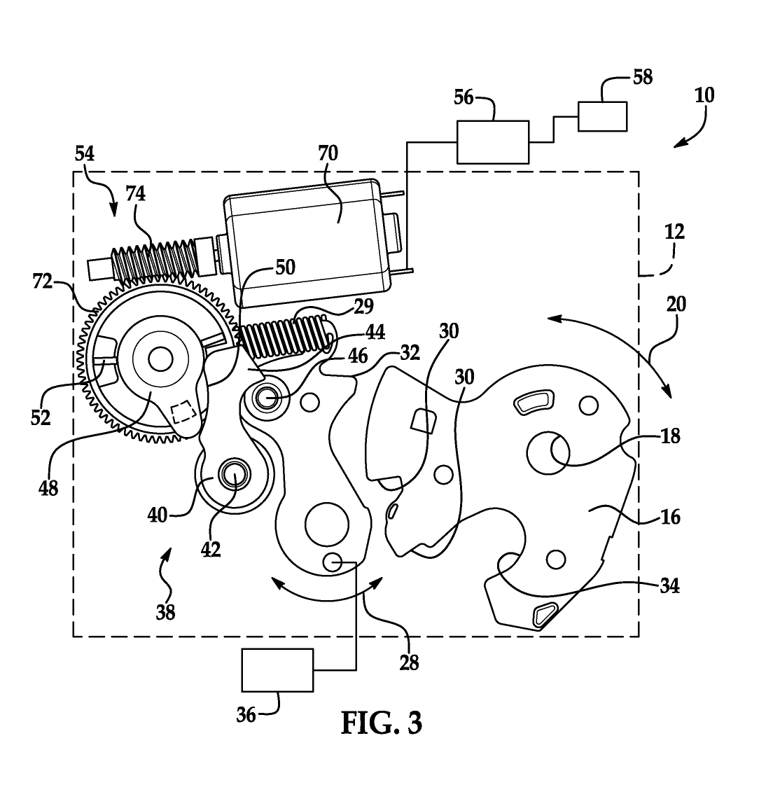

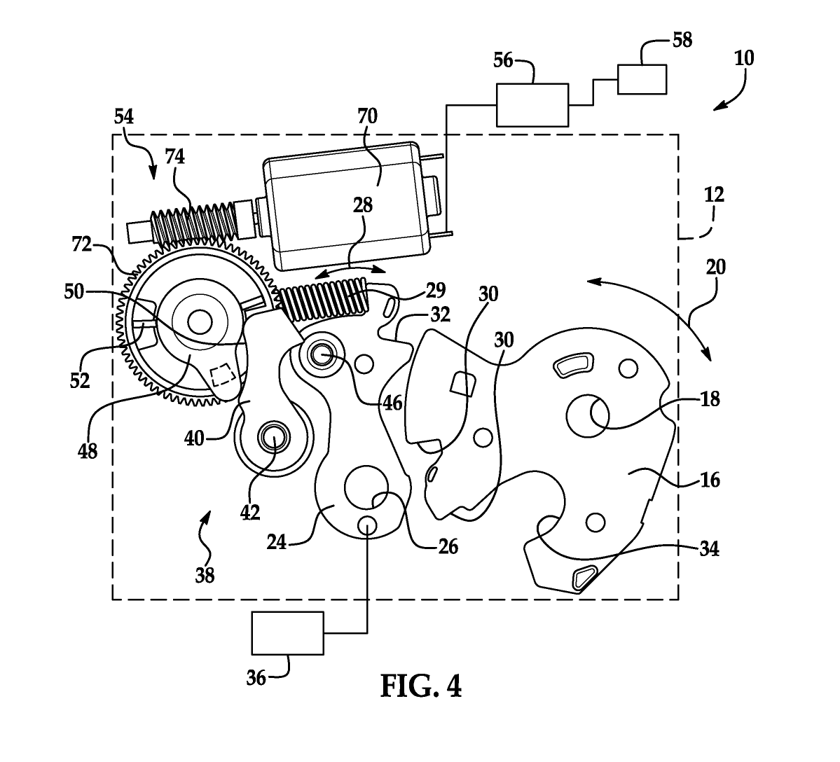

A fork bolt or fork bolt lever 16 is pivotally or rotationally mounted to frame plate 12 about a pivot pin or stud that is received within a pivot pin opening 18 of the fork bolt. Fork bolt 16 is capable of rotational or pivotal movement between an open or unlatched position shown at least in FIGS. 3 and 4 and a closed or latched position shown at least in FIGS. 1 and 2, wherein the fork bolt rotates in the direction of arrows 20.

Vehicle compartment latch 10 is attached to a vehicle structure such that fork bolt 16 is moved between the open position and the closed position when a door, window, lift gate, etc. is opened and closed and fork bolt 16 engages a striker (not shown) that is attached to the door, window, lift gate, etc. Alternatively, the vehicle compartment latch 10 is secured to the door, window, lift gate, etc. and the striker is secured to the vehicle body at an opening into which the door, window, lift gate, etc. is received. The cooperation of a fork bolt and striker is well known and need not be described in detail.

Vehicle compartment latch 10 further comprises a detent lever 24 that pivots on support or frame plate 12 about a pivot pin received within a pivot pin opening 26 in the detent lever. The detent lever cooperates with fork bolt 16 in a well known manner to retain fork bolt 16 in the closed position shown in the FIGS. 1 and 2 or release the fork bolt 16 for return to the open position. That is, detent lever 24 pivots between a closed or engaged detent position shown in at least FIGS. 1 and 2 and a release or disengaged detent position shown at least in FIGS. 3 and 4 by movement in the direction of arrows 28. In accordance with an exemplary embodiment of the present invention, fork bolt 16 is spring biased to the open position by a biasing member (e.g., coil spring or other equivalent member) that has one end attached to fork bolt 16 and the other end attached to the housing or other equivalent location. Similarly, a biasing member or spring 29 will also bias the detent lever in the direction of a face of fork bolt 16.

In accordance with exemplary embodiments of the present invention, the fork bolt has an engagement surface(s) or contact surface(s) 30 that slides along and makes contact with a complimentary engagement surface or contact surface 32 of the detent lever when the fork bolt pivots or moves from the open position to the closed position and once in the closed position surface 30 of the fork bolt engages a surface 32 of the detent lever thus engaging the fork bolt and securing it into the closed position when the striker is secured in a receiving opening 34 of the fork bolt.

Once the latch is in the closed position the detent lever is spring biased into contact with the fork bolt such that the fork bolt cannot rotate into the open position unless the detent lever is moved back to the release or disengaged detent position (e.g., moving surface 30 away from surface 32 allowing the fork bolt to rotate into the open position).

In order to move the detent lever to the disengaged position, an actuator or release handle 36 (shown schematically as box 36 coupled to the detent lever) provides a force to the detent lever in order to rotate it out of engagement with the fork bolt. Since the detent lever is spring biased towards the fork bolt the detent lever will return to the engaged position once the force from the actuator is removed.

During certain events (e.g., vehicle being driven) it is desirable to prevent the detent lever from moving to the disengaged position from the engaged position. In order to prevent the detent lever from moving to the disengaged position from the engaged position an inertia block out assembly 38 is provided. In one embodiment, the inertia block out assembly 38 prevents the detent lever from moving into the disengaged position until a predetermined force is applied to the detent lever to move it to the disengaged position.

In one non-limiting embodiment and as illustrated in the attached FIGS., the inertia block out assembly includes a block out lever 40 pivotally mounted to the frame plate 12 or a pivot pin 42 for movement between an activated position (see at least FIGS. 1 and 2) and a deactivated position (see at least FIG. 4). As the block out lever moves towards the activated position, a first cam surface 44 of the block out lever engages a feature 46 of the detent lever. Accordingly and when the detent lever is in the engaged position and the block out lever is in the activated position cam surface 44 will be in contact with feature 46.

In order to maintain the block out lever in this position a drive lever 48 is pivotally or rotationally mounted for movement between an activated position (see at least FIGS. 1 and 2) and a deactivated (see at least FIG. 4) wherein the drive lever makes contact with a second cam surface 50 of the block out lever when the drive lever is moved to the activated position. In one embodiment, the block out lever may be spring biased towards either the driver lever or the detent lever.

In one non-limiting configuration and as illustrated in the attached FIGS. the first cam surface and the second cam surface are on opposite sides of the block out lever. Also illustrated is that the drive lever is coupled to a spring 52 that provides a biasing force to the drive lever when it is in the activated position and the predetermined amount of force that must be applied to the detent lever to move it to the disengaged position is determined in part by the biasing force of the spring.

In one embodiment and in order to move the block out lever and the drive lever to the activated position, a motorized assembly 54 is provided for moving the drive lever and subsequently the block out lever into the activated position. In one embodiment, the motorized assembly is operated by a controller or microcontroller 56 that receives signals from a sensor 58, which may be a motion or speed sensor or a sensor configured to provide signals to the controller or receive signals wireless or otherwise from another source including but not limited to other sensors and/or transmission devices such as a hand held device such as a key fob or other equivalent device.

In one implementation, the motorized assembly has a motor 70 for driving a worm gear 72 via a worm 74. As illustrated, the worm gear is coupled to the drive lever via spring 52 such that rotation of the worm gear will rotate the drive lever. As illustrated, the drive lever is rotationally received on the drive lever for independent rotation with respect to the worm gear. Also shown is that the worm gear and the drive lever have the same axis 76 of rotation.

In one embodiment, the motor is a bidirectional motor such that the drive lever may be driven by the motor between an activated position and a deactivated position. Furthermore, the spring 52 pushes the drive lever to a controlled position by a hard stop on the worm gear, the spring will have a spring constant strong enough to perform normal activation and deactivation by powering the motor without any relative movement between the drive lever and the worm gear. However, the drive spring or spring 52 works also as a safety feature because it provides a dead movement on the actuator providing an emergency manual release mechanism. For example and in the case of loss of power or motor malfunction preventing normal (power) operation of the assembly wherein the block out lever is in the activated position, the driver spring 52 is configured to just add an extra load to open the door such that the extra load is sufficient to eliminate the undesired opening events due to high accelerations on the latch assembly however a higher opening force applied to the detent lever by a release handle will overcome the biasing force of spring 52 and move the detent lever out of its engaged position so the fork bolt and the door can be opened.

One non-limiting angle of rotation of the drive lever necessary for this opening to occur is illustrated by angle 78 in FIG. 2. Accordingly, the drive lever is coupled to a spring that provides a biasing force to the drive lever when it is in the activated position and the predetermined amount of force that must be applied to the detent lever to move it to the disengaged position without motor assist is determined in part by the biasing force of the spring. Other components of the total force is determined, in part, by cam surfaces 44 and 50 as well as the configuration of feature 46 and drive lever 48.

In addition, the gear ratio between the worm and the worm drive is configured to prevent the motor from being back driven and thus cause the biasing force of the spring 52 to be overcome when the predetermined amount of force is applied to the detent lever and the drive lever is rotated with respect to the worm gear. This gear ration will also provide a quite operation of the motor assembly.

Accordingly an apparatus and method for preventing a detent lever of a vehicle door latch assembly from moving to a disengaged position when the detent lever has been moved to an engaged position by a remotely activated actuator is provided.

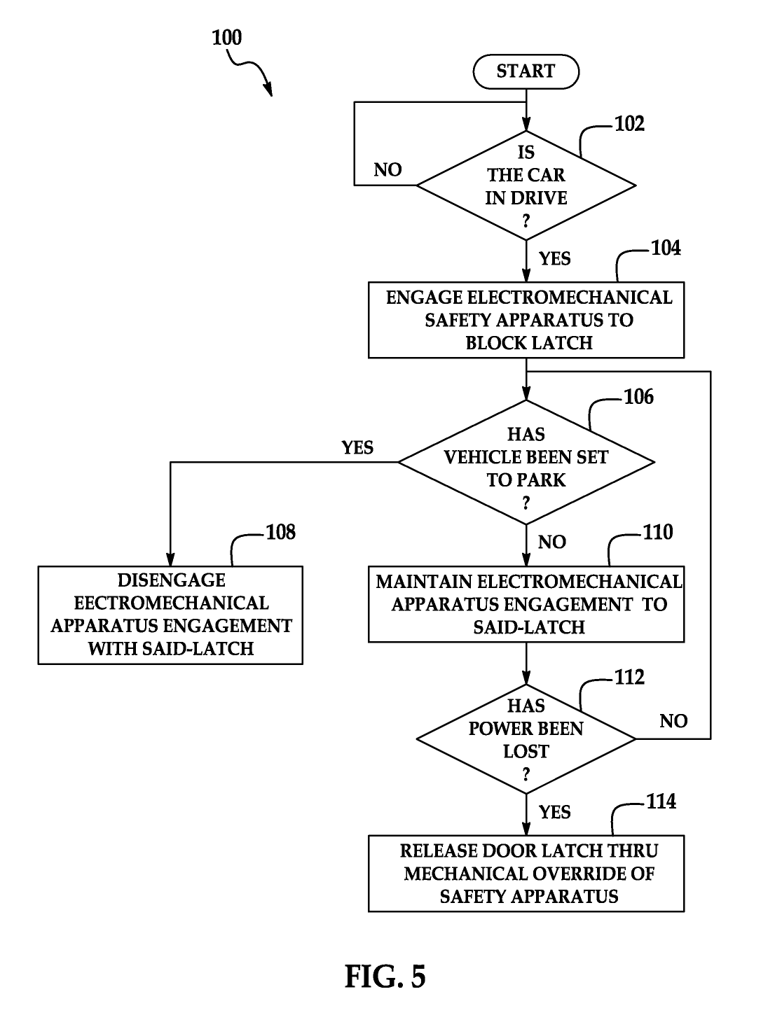

Referring now to FIGS. 1-5 and in particular FIG. 5, a flow chart 100 of a method operation of an exemplary embodiment of the present invention is illustrated. This method can be performed by an algorithm or software commands resident upon the controller or microcontroller 56. At a decision node or step 102, the system or controller will determine if the vehicle is in drive or moving by a signal received from sensor 58. As discussed above, sensor may be linked or configured to provide a signal of any suitable event for determining actuation of the assembly such as vehicle in drive and moving at predetermined speed, etc.

Thereafter and at step 104 if the vehicle is in drive and/or moving, a signal is sent from controller 56 to actuate the assembly and energize the motor to move the drive lever and the block out lever into the activated position. Alternatively, the system remains at step 102 until it is determined that the vehicle is in motion or the transmission is in drive.

Thereafter and at a decision node or step 106, the system or controller will determine if the vehicle has been placed in park or is no longer moving by continuously sampling signals received from sensor 58. If yes, the system at step 108 will deactivate the inertia block out assembly by energizing the motor and driving it in an opposite direction with respect to step 104.

If however, decision node or step 106 determines the vehicle is still in drive or still moving, the system or controller will maintain the inertia block out assembly in the activated position at step 110 wherein the drive lever and the block out lever prevent movement of the detent lever under certain conditions.

Decision node or step 112 and step 114 illustrate the manual override of the block out assembly wherein the block out lever and the drive lever may be manually moved to the deactivated position by applying a force to a release lever 36, which in one exemplary embodiment is slightly higher than typical normal opening forces but sufficient to prevent inadvertent movement of the detent lever due to acceleration forces applied to the latch assembly.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A vehicle door latch assembly, comprising:
a fork bolt movably secured to the latch assembly, the fork bolt being capable of movement between a latched position and an unlatched position;
a detent lever movably secured to the latch assembly, the detent lever being capable of movement between an engaged position and a disengaged position, the detent lever retains the fork bolt in the latched position when the detent lever is in the engaged position and an engagement surface of the detent lever contacts an engagement surface of the fork bolt; and
an inertia block out assembly for preventing the detent lever from moving into the disengaged position until a predetermined force is applied to the detent lever to move it to the disengaged position when the fork bolt is in the latched position.

2. The vehicle door latch assembly as in claim 1, wherein the inertia block out assembly comprises:
a block out lever pivotally mounted for movement between an activated position and a deactivated position, wherein a first cam surface of the block out lever engages a feature of the detent lever when the detent lever is in the engaged position and the block out lever is in the activated position.

3. The vehicle door latch assembly as in claim 2, wherein the inertia block out assembly further comprises:
a drive lever movably mounted for movement between an activated position and a deactivated position, wherein the drive lever contacts a second cam surface of the block out lever when the drive lever is moved to the activated position.

4. The vehicle door latch assembly as in claim 3, wherein the first cam surface and the second cam surface are on opposite sides of the block out lever.

5. The vehicle door latch assembly as in claim 3, wherein the drive lever is coupled to a spring that provides a biasing force to the drive lever when it is in the activated position and the predetermined amount of force that must be applied to the detent lever to move it to the disengaged position is determined in part by the biasing force of the spring.

6. The vehicle door latch assembly as in claim 5, wherein the first cam surface and the second cam surface are on opposite sides of the block out lever.

7. The vehicle door latch assembly as in claim 1, wherein the inertia block out assembly comprises:
a block out lever pivotally mounted for movement between an activated position and a deactivated position, wherein a first cam surface of the block out lever engages a feature of the detent lever when the detent lever is in the engaged position and the block out lever is in the activated position; and
a motorized assembly for moving the block out lever into the activated position, the motorized assembly having a worm gear and a drive lever, the drive lever being configured for movement between an activated position and a deactivated position, wherein the drive lever contacts a second cam surface of the block out lever when the drive lever is moved to the activated position and movement of the drive lever from the deactivated position to the activated position will move the block out lever to the activated position and wherein the drive lever and the worm gear have the same axis of rotation.

8. The vehicle door latch assembly as in claim 7, wherein the motorized assembly further comprises a bidirectional motor with a worm for driving the worm gear and accordingly the drive lever between the activated position and the deactivated position.

9. The vehicle door latch assembly as in claim 8, wherein the drive lever is coupled to a spring that provides a biasing force to the drive lever when it is in the activated position and the predetermined amount of force that must be applied to the detent lever to move it to the disengaged position is determined in part by the biasing force of the spring. in the activated position and the predetermined amount of force that must be applied to the detent lever to move it to the disengaged position is determined in part by the biasing force of the spring.

10. The vehicle door latch assembly as in claim 9, wherein a gear ratio between the worm and the worm drive is configured to cause the biasing force of the spring to be overcome and the drive lever is rotated with respect to the worm gear when the predetermined amount of force is applied to the detent lever.

11. The vehicle door latch assembly as in claim 7, wherein the drive lever is coupled to a spring that provides a biasing force to the drive lever when it is in the activated position and the predetermined amount of force that must be applied to the detent lever to move it to the disengaged position is determined in part by the biasing force of the spring.

12. A method of preventing a detent lever of a vehicle door latch assembly from moving to a disengaged position when the detent lever has been moved to an engaged position by a remotely activated actuator, the method comprising:
pivotally securing a fork bolt to the vehicle door latch assembly for movement between an unlatched position and a latched position;
pivotally securing the detent lever to the vehicle door latch assembly for movement between the engaged position and the disengaged position wherein a contact surface of the detent lever engages a contact surface of the fork bolt when the detent lever is in the engaged position and the fork bolt is in the latched position; and
preventing the detent lever from moving to the disengaged position from the engaged position by restricting movement of the detent lever until a predetermined amount of force is applied to the detent lever.

13. The method as in claim as in claim 12, wherein the detent lever is prevented from moving to the disengaged position from the engaged position by an inertia block out assembly, the inertia block out assembly comprising:
a block out lever pivotally mounted for movement between an activated position and a deactivated position, wherein a first cam surface of the block out lever engages a feature of the detent lever when the detent lever is in the engaged position and the block out lever is in the activated position.

14. The method as in claim 13, wherein the inertia block out assembly further comprises:
a drive lever movably mounted for movement between an activated position and a deactivated position, wherein the drive lever contacts a second cam surface of the block out lever when the drive lever is moved to the activated position.

15. The method as in claim 14, wherein the first cam surface and the second cam surface are on opposite sides of the block out lever.

16. The method as in claim 14, wherein the drive lever is coupled to a spring that provides a biasing force to the drive lever when it is in the activated position and the predetermined amount of force that must be applied to the detent lever to move it to the disengaged position is determined in part by the biasing force of the spring.

17. The method as in claim 12, wherein the detent lever is prevented from moving to the disengaged position from the engaged position by an inertia block out assembly, the inertia block out assembly comprising:
a block out lever pivotally mounted for movement between an activated position and a deactivated position, wherein a first cam surface of the block out lever engages a feature of the detent lever when the detent lever is in the engaged position and the block out lever is in the activated position; and
a motorized assembly for moving the block out lever into the activated position, the motorized assembly having a worm gear and a drive lever, the drive lever being configured for movement between an activated position and a deactivated position, wherein the drive lever contacts a second cam surface of the block out lever when the drive lever is moved to the activated position and movement of the drive lever from the deactivated position to the activated position will move the block out lever to the activated position and wherein the drive lever and the worm gear have the same axis of rotation.

18. The method as in claim 17, wherein the motorized assembly further comprises a bidirectional motor with a worm for driving the worm gear and accordingly the drive lever between the activated position and the deactivated position.

19. The method as in claim 18, wherein the drive lever is coupled to a spring that provides a biasing force to the drive lever when it is in the activated position and the predetermined amount of force that must be applied to the detent lever to move it to the disengaged position is determined in part by the biasing force of the spring in the activated position and the predetermined amount of force that must be applied to the detent lever to move it to the disengaged position is determined in part by the biasing force of the spring.

20. The method as in claim 19, wherein a gear ratio between the worm and the worm drive is configured to cause the biasing force of the spring to be overcome and the drive lever is rotated with respect to the worm gear when the predetermined amount of force is applied to the detent lever.
